(19) United States
(12) Patent Application Publication
(10) Pub. No.: US 2024/0200156 A1
(43) Pub. Date: Jun. 20, 2024

(54) PROCESS FOR PRODUCING RAW JUICE FOR MAKING SUGAR, PROCESS FOR MAKING SUGAR, AND SUGAR-PRODUCTION INSTALLATION

(71) Applicant: PFEIFER & LANGEN IP GMBH, Köln (DE)

(72) Inventors: Mark-Oliver BURKHARDT, Pfungstadt (DE); Wolfgang KLOSTERHALFEN, Kerpen (DE)

(21) Appl. No.: 18/287,581

(22) PCT Filed: Apr. 21, 2022
(86) PCT No.: PCT/EP2022/060614

§ 371 Date: Oct. 19, 2023

(30) Foreign Application Priority Data
Apr. 23, 2021 (EP) 21170221.2

(51) Int. Cl. C13B 10/02; C13B 10/12; G01N 21/359

(52) U.S. Cl. CPC C13B 10/02; C13B 10/12; G01N 21/359

(57) ABSTRACT

The present invention relates to a process for producing raw juice (14) for the production of sugar, wherein sugar beet pulp (11) is fed to an extraction device (20), for example an extraction tower or a diffusion trough, and sugar beet pulp residues (13) and raw juice (14) are withdrawn from the extraction device (20), wherein
a first near-infrared spectroscopy device (21) is used to detect first measurement data relating to the sugar beet pulp (11) which is fed to the extraction device (20), and/or
a second near-infrared spectroscopy device (22) is used to detect second measurement data relating to the sugar beet pulp residues (13) which are withdrawn from the extraction device (20), and/or
a third near-infrared spectroscopy device (23) is used to detect third measurement data relating to the raw juice (14) that is withdrawn from the extraction device (20).

The invention further relates to a sugar production plant and a process for producing sugar, wherein raw juice (14) is produced and sugar is produced from the raw juice (14) in subsequent process steps.

### PRIOR ART

The present invention relates to a process for producing raw juice for the production of sugar, wherein sugar beet pulp is fed to an extraction device, for example an extraction tower or a diffusion trough, and sugar beet pulp residues and raw juice are withdrawn from the extraction device. The invention further relates to a process for producing sugar. Another subject matter of the invention is a sugar production plant with an extraction device, for example an extraction tower or a diffusion trough, to which sugar beet pulp is fed and from which sugar beet pulp residues and raw juice can be withdrawn.

The production of raw juice is usually one of the first process steps in industrial sugar production, which is carried out in the sugar production plant. The sugar beets delivered to the sugar production plant are typically washed to remove adhering substances. The cleaned sugar beets are then crushed into sugar beet pulp. The actual production of the raw juice takes place in an extraction device to which the sugar beet pulp is fed. Various types of extraction devices are known, for example extraction towers or diffusion troughs. What these have in common is that the sugar beet pulp is exposed to hot water in a countercurrent process. The raw juice, which contains approximately 92% to 95% of the sucrose contained in the sugar beet pulp and some non-sugar substances, is obtained by diffusion/extraction. Extraction also produces sugar beet pulp residue, which is typically pressed into pellets and used as livestock feed.

In industrial sugar production, particularly in the extraction process, careful adjustment and, if necessary, tracking of process parameters is key. It is therefore necessary to examine the sugar beet pulp and/or the sugar beet pulp residues and/or the raw juice obtained for ingredients. For this purpose, according to the state of the art, it is common practice to take samples and examine these in a laboratory. The sampling and subsequent examination in the laboratory is associated with a certain processing time, which must be waited before the results of the analysis are available and reactions, such as tracking of process parameters, are possible.

WO 2020/027 731 A1 describes a separation process in which granulated sugar is separated from a thick juice-granulated sugar mixture, i.e. magma or massecuite, by centrifugation. In this context, WO 2020/027 731 A1 suggests using an analytical process, such as near-infrared spectroscopy (NIRS), to derive a spectrum that indicates the concentration of phenols or flavonoids in the thick juice-granulated sugar mixture. This information can be used to determine suitable operating parameters for the centrifuge.

U.S. Pat. No. 6,630,672 B1 describes a process and a system for online measurement of a stream of crushed sugar cane using near-infrared spectroscopy.

### DISCLOSURE OF THE INVENTION

Against this background, it is the problem of the present invention to enable the balancing of ingredients of the educts and/or products in the extraction process with less effort, in particular with less time and/or laboratory effort.

To solve the problem, a process for producing raw juice for the production of sugar is proposed, wherein sugar beet pulp is fed to an extraction device, for example an extraction tower or a diffusion trough, and sugar beet pulp residues and raw juice are withdrawn from the extraction device, wherein
first measurement data relating to the sugar beet pulp is detected using a first near-infrared spectroscopy device, which sugar beet pulp is fed to the extraction device, and/or
second measurement data relating to the sugar beet pulp residues is detected using a second near-infrared spectroscopy device, which sugar beet pulp residues are withdrawn from the extraction device, and/or
third measurement data relating to the raw juice that is withdrawn from the extraction device can be detected using a third near-infrared spectroscopy device.

In the process according to the invention, a near-infrared spectroscopy device or multiple near-infrared spectroscopy devices are used to detect measurement data relating to the sugar beet pulp fed to the extraction device and/or the sugar beet pulp residues and/or the raw juice withdrawn from the extraction device. These near-infrared spectroscopy device(s) enable non-contact determination of ingredients of the sugar beet pulp and/or the sugar beet pulp residues and/or the raw juice. In addition, the use of near-infrared spectroscopy device(s) offers the advantage that time-consuming sampling and examination in a laboratory can be eliminated. Instead, it is possible with the process according to the invention to determine the ingredients during the ongoing production process without removing sugar beet pulp and/or the sugar beet pulp residues and/or raw juice. The near-infrared spectroscopy device(s) also enable(s) the analysis and/or control of the extraction device and/or other devices or process steps in the sugar production process.

The one or more near-infrared spectroscopy device(s)—also referred to as NIRS device(s)—detect measurement data from which conclusions can be drawn about the ingredients of the sugar beet pulp, sugar beet pulp residues, and the raw juice being examined. The respective NIRS device makes use of a process in which the educt or product to be examined is irradiated with electromagnetic radiation in the near-infrared range, for example in a spectral range from 400 nm to 2,500 nm. Such irradiation can stimulate molecular vibrations in the material being examined. The electromagnetic radiation triggered by the molecular vibrations in the near-infrared range, for example in a spectral range from 400 nm to 2,500 nm, is detected and resolved spectroscopically. The type and/or amount of ingredients in the materials examined can be determined from the detected spectra.

The sugar beet pulp and/or sugar beet pulp residues and/or the raw juice can be detected without further treatment using the respective near-infrared spectroscopy device. Removal of the sugar beet pulp and/or sugar beet pulp residues from the production flow and/or processing is not necessary.

With regard to the raw juice, it can be advantageous if the third near-infrared spectroscopy device is arranged in a bypass line into which the raw juice is introduced, and a standing raw juice is generated to detect the third measurement data. The third measurement data can be detected with improved reproducibility on the liquid raw juice if it does not move. After the measurement has been carried out on the standing raw juice, it can be returned to the production flow.

Preferably, the measurement data detected with the respective near-infrared spectroscopy device can result from multiple measurements from different directions. For this purpose, the respective near-infrared spectroscopy device comprises a plurality of detectors which are arranged with different orientations relative to the material being examined. By means of such non-contact measurement from multiple directions, the ingredients can be determined with increased accuracy from the respective measurement data.

According to an advantageous embodiment of the invention, one or more geometric properties of the sugar beet pulp, in particular a length and/or a width and/or a cross-sectional area, are determined using an optical imaging device. The additionally determined optically detectable properties of the sugar beet pulp can improve the analysis and/or tracking of the extraction process. The optical imaging device is preferably directed to the same area of the production flow as the first near-infrared spectroscopy device, so that the first measurement data of the near-infrared spectroscopy device and the properties determined by the optical imaging device relate to identical sugar beet pulp.

Preferably, the sugar beet pulp residues withdrawn from the extraction device are pressed, wherein residual water is produced, and fourth measurement data relating to the residual water produced when the sugar beet pulp residues are pressed is detected using a fourth near-infrared spectroscopy device.

Particularly preferably, the fourth near-infrared spectroscopy device is arranged in a bypass line into which the residual water is introduced, and standing residual water is generated to detect the fourth measurement data. The fourth measurement data can be detected with improved reproducibility in the residual water if it does not move. After carrying out the measurement on the remaining standing water, it can be withdrawn from the bypass line.

It is particularly advantageous if the sugar beet pulp residues removed from the extraction device are pressed, wherein residual water is produced, and fifth measurement data relating to the pressed sugar beet pulp residues obtained when the sugar beet pulp residues are pressed is detected using a fifth near-infrared spectroscopy device.

In an advantageous embodiment of the process according to the invention, at least one process parameter of the extraction device is set as a function of the first measurement data and/or the second measurement data and/or third measurement data and/or fourth measurement data and/or, if applicable, the geometric property/properties of the sugar beet pulp. Setting the process parameters depending on the measurement data detected by one or more of the near-infrared spectroscopy device(s) and/or using the optical imaging device can enable tracking of the process parameters of one of the subsequent process steps with low latency. The process parameter can be, for example, an extraction time, which indicates the duration for which the sugar beet pulp remains in the extraction device and/or an extraction temperature, which indicates the temperature at which the extraction device is operated. Alternatively or additionally, the process parameter can be an amount of fresh water that is supplied to the extraction device and/or a fill level in the extraction device. For example, a yield of the extraction process can be determined based on the first and/or second and/or third measurement data, wherein an amount of fresh water in the extraction device and/or the extraction temperature is increased if the yield decreases.

In an advantageous design of the process, the sugar beet pulp is cut from sugar beets using a cutting machine and a process parameter of the cutting machine is set depending on the first measurement data and/or the second measurement data and/or third measurement data and/or, optionally, the geometric property/properties of the sugar beet pulp. Setting the process parameters depending on the measurement data detected by one or more of the near-infrared spectroscopy devices and/or the properties determined by the optical imaging device can enable tracking of the process parameters of the cutting machine with low latency. For example, it can be found that a geometric property, for example a length and/or a width and/or a cross-sectional area and/or a specific surface, is smaller than a predetermined minimum value and a process parameter of the cutting machine can be modified such that larger sugar beet pulp is cut. Or it can be found that the geometric property is greater than a predetermined maximum value and a process parameter of the cutting machine can be modified such that smaller sugar beet pulp is cut. The geometric property can be determined as a measure of a distribution of the length and/or distribution of the width and/or distribution of the cross-sectional area and/or distribution of the surface. It is particularly suitable if a length distribution and/or a distribution of the specific surface area is determined as the geometric property of the sugar beet pulp. Sugar beet pulp of uniform length leads to a good extraction result because it offers a large surface area and at the same time its length ensures that the mixture of water and sugar beet pulp can flow through well. Although short sugar beet pulp has a large surface area, it makes the mass transfer in the separation of sugar beet pulp and juice more difficult, for example in the bottom sieves of an extraction tower. A high proportion of only partially cut sugar beets, for example in the form of slices, leads to a smaller surface area and thus poorer mass transfer. Sugar beet pulp of uniform length offers better pressing in the pulp presses and therefore lower energy consumption as well as improved recovery of residual sugar from the sugar pulp.

To solve the problem mentioned at the outset, a process for producing sugar is also proposed, in which raw juice is produced according to a process described above and sugar is produced from the raw juice in subsequent process steps.

The process for producing sugar can achieve the same advantages that have already been described in connection with the process for producing raw juice.

According to an advantageous design of the process for producing sugar, at least one process parameter of one of the subsequent process steps is set as a function of the first measurement data and/or the second measurement data and/or third measurement data and/or, optionally, the geometric properties of the sugar beet pulp. Setting the process parameters depending on the measurement data detected by one or more of the near-infrared spectroscopy devices and/or the properties determined by the optical imaging device can enable tracking of the process parameters of one of the subsequent process steps with low latency.

Preferably, the subsequent process step is a liming step or a carbonation step or a filtration step or a thickening step or a crystallization step or a separation step. In the liming step, for example, an added amount of lime milk, a lime milk composition or concentration, a pH value, an added amount of precipitated calcium carbonate(PCC for short) or a carbonated juice withdrawal can be set as process parameters. In the thickening step and/or crystallization step, for example, a temperature or a residence time can be set as a process parameter.

In addition to the advantageous designs explained above, the advantageous designs and features described in connection with the process for producing raw juice can also be used alone or in combination in the process for producing sugar.

The invention further relates to a sugar production plant with an extraction device, for example an extraction tower or a diffusion trough, to which sugar beet pulp is fed and from which sugar beet pulp residues and raw juice can be withdrawn, with
a first near-infrared spectroscopy device for detecting first measurement data relating to the sugar beet pulp, which is fed to the extraction device, and/or
a second near-infrared spectroscopy device for detecting second measurement data relating to the sugar beet pulp residues, which are withdrawn from the extraction device, and/or
a third near-infrared spectroscopy device for detecting third measurement data relating to the raw juice that is withdrawn from the extraction device.

In the sugar production plant, the same advantages can be achieved that have already been described in connection with the process for producing sugar.

According to an advantageous design of the sugar production plant according to the invention, it comprises an optical imaging device for determining one or more geometric properties of the beet pulp, in particular a length and/or a width and/or a cross-sectional area. By additionally determining optically detectable properties of the sugar beet pulp, the analysis and/or tracking of the extraction process can be further improved. The optical imaging device is preferably directed to the same area of the production flow as the first near-infrared spectroscopy device, so that the first measurement data of the near-infrared spectroscopy device and the properties determined by the optical imaging device relate to identical sugar beet pulp.

In a preferred embodiment of the invention, the sugar production plant comprises a cutting machine for cutting the sugar beet pulp from sugar beets, wherein the optical imaging device is arranged in the output area of the cutting machine. This makes it possible to analyze the sugar beet pulp cut by the cutting machine and to adjust the operating mode of the cutting machine depending on this analysis.

In the sugar production plant, the advantageous designs and features described in connection with the process explained above can be used alone or in combination.

Further advantages, features, and details of the invention will be apparent from the drawings as well as from the following description of a preferred exemplary embodiment based on the drawings. The drawings merely illustrate an exemplary embodiment of the invention, which does not limit the inventive concept.

### BRIEF DESCRIPTION OF THE FIGURES

FIG. 1 shows a process for producing sugar according to a first exemplary embodiment of the invention.

FIG. 2 shows a process for producing raw juice according to a first exemplary embodiment of the invention.

### EMBODIMENTS OF THE INVENTION

In the various figures, the same parts are always provided with the same reference numerals and are therefore usually only named or mentioned once.

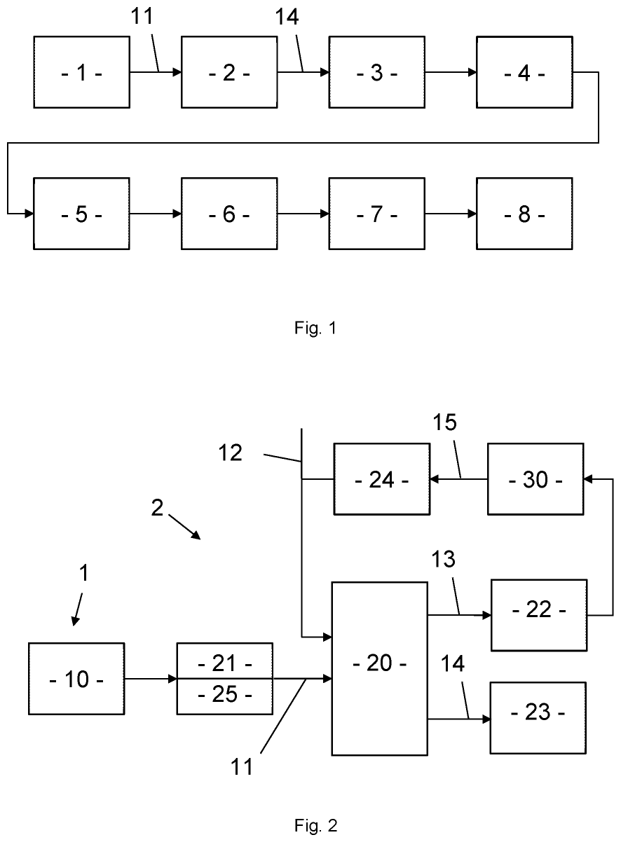

The flow chart shown in FIG. 1 shows an exemplary embodiment of a process according to the invention for producing sugar, which is carried out in a sugar production plant. The sugar beets delivered to the sugar production plant are preferably first cleaned, that is, freed from adherent substances such as soil, sand, or leaves. In a first process step of cutting 1, the sugar beets are crushed by a cutting machine to obtain sugar beet pulp 11.

The sugar beet pulp is leached by water in an extraction device in an extraction process step 2 or juice extraction step following cutting 1. Optionally, the sugar beet pulp can first be preheated, for example in a range from 60° C. to 80° C., to make the cell walls more permeable. The actual extraction 2 takes place in a countercurrent process in which the sugar beet pulp is conveyed or passed through the extraction device in a countercurrent to hot water. The product of extraction 2, in addition to sugar beet pulp residue, is raw juice 14, which contains almost all of the sugar contained in the sugar beets. Details of the extraction 2 are explained below in connection with FIG. 2.

Lime in the form of lime milk is added to the raw juice 14 in a liming process step 3. The lime binds non-sugar substances contained in the raw juice 14. Acids are neutralized and the pH value is raised.

In the subsequent process step of carbonation 4, carbon dioxide is introduced into the mixture of raw juice and lime milk. Calcium and other non-sugar substances are bound and precipitate as lime (calcium carbonate). In the subsequent process step of filtration 5, the lime is then separated off and the thin juice remains. The process steps of liming 3, carbonization 4, and filtration 5 are also referred to as juice purification. The steps of liming 3, carbonation 4, and filtration 5 can optionally be carried out in this order multiple times, for example twice in a row, to improve the cleaning result.

This is followed by the process step of thickening 6, in which the thin juice is thickened in a usually multi-stage heating process to obtain the thick juice.

Sugar is crystallized from the thick juice in a crystallization process step 7 at a moderate or high temperature, such as approx. 70° C., and negative pressure. The crystallization 7 preferably comprises multiple successive crystallization steps. A mixture of thick juice and granulated sugar is obtained, which is also known as magma.

Finally, the granulated sugar is separated in a separation process step 8, for example in a centrifuge.

In the process according to FIG. 1, an extraction step 2 according to the invention is used, which will be explained below using the illustration in FIG. 2.

In the extraction step 2, an extraction device 20 is used, which is configured, for example, as an extraction tower or diffusion trough. In the extraction device 20, the sugar beet pulp 11 cut by the cutting machine 10 is subjected to hot water 12 in a countercurrent process in order to leach the raw juice 14 from the sugar beet pulp 11. Leached sugar beet pulp residues 13 remain. These are pressed in a press 30 to dry. The residual water 15 obtained during pressing is heated and fed to the extraction device 20 together with fresh water 12.

Special measures are taken in extraction step 2 to enable balancing the ingredients of the educts and/or products in the extraction process with less effort. First measurement data relating to the sugar beet pulp 11 are detected using a first near-infrared spectroscopy device 21. An optical imaging device 25 determines, in particular simultaneously, one or more geometric properties of the sugar beet pulp 11, in particular a length and/or a width and/or a cross-sectional area. Both the first near-infrared spectroscopy device 21 and the optical imaging device 25 are arranged in the output area of the cutting machine 10. Second measurement data relating to the sugar beet pulp residues 13 withdrawn from the extraction device 20 are detected using a second near-infrared spectroscopy device 22. And a third near-infrared spectroscopy device 23 detects third measurement data relating to the raw juice 14.

The third near-infrared spectroscopy device 23 is arranged in a third bypass line, into which the raw juice 14 is introduced, and a standing raw juice is generated to detect the third measurement data. After the measurement data has been detected, the raw juice 14 is returned to the production flow and sent for juice purification (process steps 3, 4, 5).

The extraction step according to FIG. 2 additionally comprises a fourth near-infrared spectroscopy device 24, with which fourth measurement data relating to the residual water 15 formed when the sugar beet pulp residues 13 are pressed are detected.

The measurement data from the near-infrared spectroscopy device(s) 21, 22, 23, 24 can, for example, indicate the detection of the following ingredients or their content: sucrose, fructose, glucose, lactic acid, oxalic acid, oxalates, nitrates, nitrites, pectins, dextrans, nitrogen. The optical imaging device can additionally determine information about the color of the material being examined, for example in the lab color room.

The measurement data from the near-infrared spectroscopy devices 21, 22, 23, 24 and the geometric properties of the sugar beet pulp 11 are used to set one or more process parameters of the extraction device 20. For example, an extraction time and/or an extraction duration can be set depending on the measurement data. For example, an extraction time and/or an extraction duration can be set depending on the first measurement data or the ingredients or the composition of the sugar beet pulp 11, respectively. Additionally or alternatively, it is possible to set the extraction time and/or an extraction duration depending on the second measurement data relating to the sugar beet pulp residues 13 and/or the third measurement data relating to the raw juice 14, such that the processing of the sugar beet pulp 11 following the measured material can be changed.

The detected measurement data from the near-infrared spectroscopy devices 21, 22, 23, 24 as well as the geometric properties of the sugar beet pulp 11 are also used to control and/or track the cutting machine 10 used in the cutting process step 1. For example, a knife quality and/or a chip size of the sugar beet pulp 11 obtained during cutting 1 can be set depending on a geometric property of the sugar beet pulp 11, for example the length and/or width and/or cross-sectional area. In addition, process parameters of one or more of the subsequent process steps 3, 4, 5, 6, 7 or 8 can be set depending on the first measurement data and/or the second measurement data and/or third measurement data and/or the geometric properties of the sugar beet pulp. Setting the process parameters depending on the measurement data detected by one or more of the near-infrared spectroscopy devices and/or the properties determined by the optical imaging device can enable tracking of the process parameters of one of the subsequent process steps with low latency.

The process and system described above makes it possible to balance the ingredients of the educts and/or products in the extraction process with less effort, in particular with little time and/or laboratory effort. This enables improved control of the processes in sugar production.

The extraction process can be balanced as the difference in the amount of sugar in the educts and products, i.e. as

amount of sugar(educts)−amount of sugar(products)

or by the yield, i.e. the amount of sugar in the raw juice 14 based on the amount of sugar in the sugar beet pulp 11.

To be able to control the extraction process as precisely as possible, it is desirable to know the sugar content of the sugar beet pulp residues 13 (wet pulp) withdrawn from the extraction device 20. However, due to the relatively high moisture content of these sugar beet pulp residues 13, determining the sugar content using the second near-infrared spectroscopy device is difficult. Pressing the sugar beet pulp residues 13 in the press 30 can provide a remedy here, wherein the residual water obtained during pressing is measured with the fourth near-infrared spectroscopy device 24 and the pressed sugar beet pulp obtained during pressing is measured with a fifth near-infrared spectroscopy device. In this respect, the sugar content in the residual water and in the pressed sugar beet pulp residues can be obtained and conclusions can be drawn about the sugar content in the sugar beet pulp residues 13 (wet pulp) withdrawn from the extraction device 20. With this knowledge, the extraction process can be accounted for as follows:

Amount of substance(sugar beet pulp)*sugar content(sugar beet pulp)−(amount of substance(raw juice)*sugar content(raw juice)+amount of sugar(sugar beet pulp residues))=losses

### LIST OF REFERENCE NUMERALS

1 “Cutting” process step
2 “Extracting” process step
3 “Liming” process step
4 “Carbonation” process step
“Filtration” process step
6 “Thickening” process step
7 “Crystallization” process step
8 “Separation” process step
10 cutting machine
11 sugar beet pulp
12 water
13 sugar beet pulp residues
14 raw juice
15 residual water
20 extraction device
21 near-infrared spectroscopy device
22 near-infrared spectroscopy device
23 near-infrared spectroscopy device
24 near-infrared spectroscopy device
25 optical imaging device
30 press

1. A process for the production of raw juice for the production of sugar, wherein sugar beet pulp is fed to an extraction device, for example an extraction tower or a diffusion trough, and sugar beet pulp residues as well as raw juice from the extraction device are withdrawn,
characterized in that
a first near-infrared spectroscopy device is used to detect first measurement data relating to the sugar beet pulp which is fed to the extraction device, and/or
a second near-infrared spectroscopy device is used to detect second measurement data relating to the sugar beet pulp residues which are withdrawn from the extraction device, and/or
a third near-infrared spectroscopy device is used to detect third measurement data relating to the raw juice that is withdrawn from the extraction device.

2. The process according to claim 1, characterized in that the third near-infrared spectroscopy device is arranged in a bypass line into which the raw juice is introduced, and a standing raw juice is generated to detect the third measurement data.

3. The process according to claim 1, characterized in that the measurement data detected using the respective near-infrared spectroscopy device can result from multiple measurements from different directions.

4. The process according to a claim 1, characterized in that one or more geometric properties of the sugar beet pulp in particular a length and/or a width and/or a cross-sectional area, are determined using an optical imaging device.

5. The process according to claim 1, characterized in that the sugar beet pulp withdrawn from the extraction device is pressed, wherein residual water is produced, and fourth measurement data relating to the residual water produced during the pressing of the sugar beet pulp residues is detected using a fourth near-infrared spectroscopy device.

6. The process according to claim 5, characterized in that the fourth near-infrared spectroscopy device is arranged in a bypass line into which the residual water is introduced, and standing residual water is produced to detect the fourth measurement data.

7. The process according to claim 1, characterized in that at least one process parameter of the extraction device is set depending on the first measurement data and/or the second measurement data and/or the third measurement data and/or the fourth measurement data and/or, optionally, the geometric properties of the sugar beet pulp.

8. The process according to claim 7, characterized in that the at least one process parameter is an extraction time which indicates the duration for which the sugar beet pulp remains in the extraction device and/or an extraction temperature which indicates the temperature at which the extraction device is operated.

9. The process according to claim 7, characterized in that the at least one process parameter is an amount of fresh water that is supplied to the extraction device and/or a fill level in the extraction device.

10. The process according to claim 1, characterized in that the sugar beet pulp is cut from sugar beets using a cutting machine and a process parameter of the cutting machine is set depending on the first measurement data and/or the second measurement data and/or the third measurement data and/or, optionally, the geometric properties of the sugar beet pulp.

11. A process for the production of sugar, wherein raw juice is produced according to a process according to claim 1 and sugar is produced from the raw juice in subsequent process steps.

12. The process of claim 11, characterized in that at least one process parameter of any one of the subsequent process steps is set depending on the first measurement data and/or the second measurement data and/or third measurement data and/or, optionally, the geometric properties of the sugar beet pulp.

13. The process according to claim 12, characterized in that the subsequent process step is a liming step or a carbonization step or a filtration step or a thickening step or a crystallization step or a separation step.

14. A sugar production plant with an extraction device, for example an extraction tower or a diffusion trough, to which sugar beet pulp can be fed and from which sugar beet pulp residues and raw juice can be withdrawn,
characterized by
a first near-infrared spectroscopy device for detecting first measurement data relating to the sugar beet pulp, which is fed to the extraction device (20), and/or
a second near-infrared spectroscopy device for detecting second measurement data relating to the sugar beet pulp residues, which are withdrawn from the extraction device, and/or
a third near-infrared spectroscopy device a for detecting third measurement data relating to the raw juice that is withdrawn from the extraction device.

15. The sugar production plant according to claim 14, characterized in that the respective near-infrared spectroscopy device comprises multiple detectors which are arranged with different orientations relative to the material being examined.

16. The sugar production plant according to claim 14, characterized by an optical imaging device for determining one or more geometric properties of the beet pulp in particular a length and/or a width and/or a cross-sectional area.

17. The sugar production plant according to claim 16, characterized by a cutting machine for cutting the sugar beet pulp from sugar beets, wherein the optical imaging device is arranged in the output area of the cutting machine.

18. The sugar production plant of claim 15, characterized by:
an optical imaging device for determining one or more geometric properties of the beet pulp, in particular a length and/or a width and/or a cross-sectional area; and
a cutting machine for cutting the sugar beet pulp from sugar beets, wherein the optical imaging device is arranged in the output area of the cutting machine.

19. The process according to claim 1, characterized in that:
the measurement data detected using the respective near-infrared spectroscopy device can result from multiple measurements from different directions; and
one or more geometric properties of the sugar beet pulp, in particular a length and/or a width and/or a cross-sectional area, are determined using an optical imaging device; and
the sugar beet pulp withdrawn from the extraction device is pressed, wherein residual water is produced, and fourth measurement data relating to the residual water produced during the pressing of the sugar beet pulp residues is detected using a fourth near-infrared spectroscopy device; and
the fourth near-infrared spectroscopy device is arranged in a bypass line into which the residual water is introduced, and standing residual water is produced to detect the fourth measurement data.

20. The process according to claim 1, characterized in that:
at least one process parameter of the extraction device is set depending on the first measurement data and/or the second measurement data and/or the third measurement data and/or the fourth measurement data and/or, optionally, the geometric properties of the sugar beet pulp;
wherein the at least one process parameter is an extraction time which indicates the duration for which the sugar beet pulp remains in the extraction device and/or an extraction temperature which indicates the temperature at which the extraction device is operated;
wherein the at least one process parameter is an amount of fresh water that is supplied to the extraction device and/or a fill level in the extraction device;
wherein the sugar beet pulp is cut from sugar beets using a cutting machine and a process parameter of the cutting machine is set depending on the first measurement data and/or the second measurement data and/or the third measurement data and/or, optionally, the geometric properties of the sugar beet pulp.
